(19) United States
(12) Patent Application Publication
(10) Pub. No.: US 2026/0368504 A1
(43) Pub. Date: Nov. 19, 2026

(54) METHODS AND SYSTEMS FOR ON-CHIP LEARNING FOR SPIKING TRANSFORMER ARCHITECTURES

(71) Applicants: Huawei Technologies Canada Co., Ltd., Kanata (CA); The University of Ottawa, Ottawa (CA)

(72) Inventors: Richard Naud, Ottawa (CA); Xingyun Wang, Ottawa (CA); Parsa Omidi, Thornhill (CA); Armaghan Eshaghi, Aurora (CA)

(21) Appl. No.: 19/337,453

(22) Filed: Sep. 23, 2025

Related U.S. Application Data
(60) Provisional application No. 63/806,463, filed on May 15, 2025.

(51) Int. Cl. G06N 3/049; G06N 3/045; G06N 3/063

(52) U.S. Cl. CPC G06N 3/049; G06N 3/045; G06N 3/063

(57) ABSTRACT

There are provided methods and systems for training a spiking transformer on-chip, using local learning rules. In examples, the spiking transformer network of the present disclosure may include a plurality of artificial neurons and a plurality of artificial synapses. The network may be trained over a plurality of training iterations, each including: propagating a feedforward signal through a plurality of feedforward connections of the network, determining a loss based on a comparison of the spiking transformer network output to a target output, encoding the loss in a feedback signal for propagating through a plurality of feedback connections of the spiking transformer network and updating synaptic weights of the spiking transformer network based on a simultaneous processing of the feedforward signal and the feedback signal using a burst-dependent local learning rule. The disclosed methods and systems may provide an energy-efficient solution to perform on-chip learning in neuromorphic hardware.

### CROSS-REFERENCE TO RELATED APPLICATION

This application claims priority to and benefit of U.S. Provisional Patent Application No. 63/806,463 filed May 15, 2025, the entire contents of which are incorporated by reference.

### FIELD

The present disclosure relates to the field of machine learning, in particular, to spiking neural networks (SNN), and yet more particularly, to spiking transformers, and more specifically, to methods and systems for on-chip learning for spiking transformer architectures.

### BACKGROUND

A generative Artificial Intelligence (AI) model, such as a large language model (LLM), is a type of machine learning (ML) model that can generate new content (such as text, images, audio or code etc.) based on learned patterns and relationships. More specifically, a LLM may be trained to learn billions of parameters, for example, to model how words relate to each other in a textual sequence, in order to generate text and other content.

Many generative AI models are based on a transformer architecture. Transformer models have revolutionized natural language processing (NLP) and have been adapted to other domains such as computer vision, audio processing and protein structure prediction, as examples. Attention mechanisms form the core process of Transformer models. They provide an adaptive weighting based on the dependencies between individual elements (tokens) in sequential data. However, due to their large size, current transformer models suffer from many drawbacks, including high computational cost (e.g., processing power, memory etc.), high infrastructure costs, and high latency, particularly in the inference phase. In particular, transformers are costly to train, demanding substantial energy on conventional von Neumann hardware.

Given the extensive resource consumption associated with training transformer models, different approaches have been proposed to train transformers more efficiently. For example, some software solutions focus on developing more efficient attention mechanisms, such as multihead latent attention (MLA) to reduce training costs. However, these methods operate on von Neumann hardware, in which energy is lost in the communication between the memory units and the processor. This has spurred interest in spiking transformer models suitable for autonomous neuromorphic chips. Neuromorphic chips are designed to mimic both the structure and function of the human brain, for example, using spiking neurons and local learning rules (e.g., plasticity rules) for event driven computation. A spiking transformer is a type of neural network architecture that combines the transformer model with spiking neural networks (SNNs), which are biologically inspired and operate using discrete spikes instead of continuous activations. SNNs are considered an energy-efficient architecture in AI due to their non-von Neumann architecture and their sparse, event-driven codes.

Accordingly, improvements in training complex transformer-based models are desired.

### SUMMARY

For on-chip learning with spiking neural networks, neuromorphic hardware requires a local learning rule to solve complex tasks. Two-factor local learning rules, such as Spike-Timing Dependent Plasticity (STDP), may enable neural networks to update weights as a function of on pre- and post-synaptic neuron states, for example, using unsupervised learning. In this way, two-factor learning rules enable SNNs to complete relatively simple tasks, however this approach hinders training SNNs with more complex architectures. In some examples, more powerful learning may be enabled by three-factor learning rules, where the third factor (e.g., in addition to pre- and post-synaptic neuron states) inserts globally available reward information, or biological supervised learning rules, such as behavioral-time-scale plasticity (BTSP), among other approaches. Use of three-factor learning rules have demonstrated the potential to complete harder tasks in complex networks. Unfortunately, existing spiking transformers lack a local learning rule, therefore hindering on-chip learning and energy efficiency by maintaining reliance on a von Neumann architecture for the training phase.

In various examples, the present disclosure describes methods and systems for training a spiking transformer on-chip, using local learning rules. In this way, training the spiking transformer on-chip bypasses the von Neumann architecture, enabling improved computational efficiency associated with model training. The proposed solution is based on biologically inspired burst-dependent synaptic plasticity and burst-dependent synaptic communication (e.g., features that enable supervised learning in multi-layer perceptrons). To capture a distinctive feature of transformers, for example, the nested inner product, the proposed solution includes a dendritic architecture for which a burst-dependent learning rule can be derived.

In examples, the spiking transformer network of the present disclosure may include a plurality of artificial neurons and a plurality of artificial synapses, where the model is trained in a first stage using a first training set over a plurality of training iterations. In examples, each training iteration may include propagating a feedforward signal through a plurality of feedforward connections of the spiking transformer network, where the feedforward connections are associated with either a first subset of the plurality of artificial neurons configured to compute a nested inner product (NIP) or a second subset of the plurality of artificial neurons configured to compute a weighted inner product (WIP), determining a loss based on a comparison of the spiking transformer network output to a target output, encoding the loss in a feedback signal for propagating through a plurality of feedback connections of the spiking transformer network and updating synaptic weights of the spiking transformer network based on a simultaneous processing of the feedforward signal and the feedback signal using a burst-dependent local learning rule. The disclosed methods and systems may provide an energy-efficient solution to perform on-chip learning in neuromorphic hardware.

In various examples, the present disclosure provides the technical effect that the spiking transformer network can be trained more efficiently using energy efficient computations associated with neuromorphic hardware. For example, neuromorphic computation mimics the architecture, operational principles and efficiency of the human brain, thereby reducing energy consumption compared to traditional computing. In addition to bypassing the von Neumann bottleneck (e.g., increased energy consumption and latency caused by frequent data transfer between separate memory and processing units), neuromorphic systems further leverage the benefits of low-precision (e.g., binary) data transmission and event-driven computation to improve computational efficiency. In contrast to traditional computing systems, which consume power continuously due to clock-driven operations, computation in SNNs only occurs when a neuron is activated, thereby further reducing power and resource consumption.

Advantageously, neuromorphic systems can learn and adapt in real-time (e.g., during inference), often directly on an edge device, thereby eliminating the need to exchange data or otherwise interface with centralized, energy intensive cloud-based resources. This can be beneficial for applications such as autonomous vehicles, wearable devices or smart sensors, which may operate on resource-constrained devices, among other possibilities.

In an example aspect, the present disclosure describes a computer-implemented method for training a spiking transformer model on a neuromorphic computing device, the spiking transformer model comprising a plurality of artificial neurons and a plurality of artificial synapses. The method includes: receiving a training set including multiple spike trains; and training the spiking transformer model in a first stage using the first training set, wherein training comprises performing a plurality of training iterations for training the spiking transformer model, each training iteration comprising: propagating a feedforward signal through a plurality of feedforward connections of the spiking transformer model, the feedforward connections associated with either a first subset of the plurality of artificial neurons configured to compute a nested inner product (NIP) or a second subset of the plurality of artificial neurons configured to compute a weighted inner product (WIP), to generate a spiking transformer model output; determining a loss based on a comparison of the spiking transformer model output to a target output; encoding the loss in a feedback signal for propagating through a plurality of feedback connections of the spiking transformer model; and updating synaptic weights of the spiking transformer model based on a simultaneous processing of the feedforward signal and the feedback signal using a burst-dependent local learning rule.

In an example of the preceding example aspect of the method, obtaining a set of trained model parameters, the model parameters having been generated according to the preceding example aspect of the method.

In an example of a preceding example aspect of the method, wherein the training is implemented on a neuromorphic chip.

In an example of a preceding example aspect of the method, wherein the feedforward signal is encoded with rates of spikes and the feedback signal is encoded with rates of bursts.

In an example of a preceding example aspect of the method, wherein the feedforward signal and the feedback signal are encoded with time to first spike (TTFS) encoding.

In an example of a preceding example aspect of the method, wherein feedforward connections and feedback connections are communicated via burst multiplexing.

In an example of a preceding example aspect of the method, wherein the plurality of artificial neurons represents a plurality of spiking neurons, each comprising a basal dendrite and an apical dendrite.

In an example of the preceding example aspect of the method, wherein the apical dendrite controls whether an event is a burst or a single spike.

In an example of a preceding example aspect of the method, wherein propagating the feedforward signal through the plurality of feedforward connections associated with the first subset of the plurality of artificial neurons comprises: mapping the feedforward signal to a query matrix (Q) based on a query weight matrix (Wq); mapping the feedforward signal to a key matrix (K) based on a key weight matrix (Wk); computing a first nested inner product by pairwise multiplication and summation of elements in the key matrix and the query matrix, wherein the first nested inner product represents a somatic input to a QK neuron of the spiking transformer model for generating a spiking output at the QK neuron represented as a QK event train; generating an inhibitory neuron output associated with an inhibitory neuron of the spiking transformer model, based on the QK event trains; mapping the feedforward signal to a value matrix (V) based on a value weight matrix (Wv); and computing a second nested inner product by pairwise multiplication and summation of elements in the value matrix and the inhibitory neuron output, wherein the second nested inner product represents a somatic input to a V neuron of the spiking transformer model for generating a spiking output at the V neuron represented as a V event train.

In an example of a preceding example aspect of the method, wherein the plurality of artificial neurons represents a plurality of spiking neurons, each comprising a basal dendrite and an apical dendrite, and wherein updating the synaptic weights comprises: receiving the feedback signal at an apical dendrite of a current artificial neuron of the plurality of artificial neurons; receiving an eligibility trace associated with a previous artificial neuron of the plurality of artificial neurons; and updating a synaptic weight matrix of the current artificial neuron when the burst-dependent local learning rule indicates that the feedback signal satisfies a gating condition for plasticity associated with the current artificial neuron, the burst-dependent local learning rule being determined based on the received feedback signal, the eligibility trace and a pre-determined learning rate.

In an example of a preceding example aspect of the method, wherein the spiking transformer model output represents an instantaneous event rate, and the target output represents a target event rate.

In an example of a preceding example aspect of the method, further comprising: prior to receiving the training set, generating the training set by encoding an input data representing a sequence of tokens into the temporal spike trains using a biologically inspired encoding scheme.

In an example of a preceding example aspect of the method, further comprising: outputting a trained spiking transformer model configured for deployment on neuromorphic hardware.

In an example aspect, the present disclosure describes a neuromorphic computing device comprising: one or more neuromorphic cores configured to implement a set of artificial neurons; a memory; and a processing circuitry to implement the set of artificial neurons to train a spiking transformer model by: receiving a first training set including multiple spike trains; and training the spiking transformer model in a first stage using the first training set, wherein training comprises performing a plurality of training iterations for training the spiking transformer model, each training iteration comprising: propagating a feedforward signal through a plurality of feedforward connections of the spiking transformer model, the feedforward connections associated with either a first subset of the plurality of artificial neurons configured to compute a nested inner product (NIP) or a second subset of the plurality of artificial neurons configured to compute a weighted inner product (WIP), to generate a spiking transformer model output; determining a loss based on a comparison of the spiking transformer model output to a target output; encoding the loss in a feedback signal for propagating through a plurality of feedback connections of the spiking transformer model; and updating synaptic weights of the spiking transformer model based on a simultaneous processing of the feedforward signal and the feedback signal using a burst-dependent local learning rule.

In an example of the preceding example aspect of the device, wherein the feedforward signal is encoded with rates of spikes and the feedback signal is encoded with rates of bursts.

In an example of a preceding example aspect of the device, wherein the feedforward signal and the feedback signal are encoded with time to first spike (TTFS) encoding.

In an example of a preceding example aspect of the device, wherein feedforward connections and feedback connections are communicated via burst multiplexing.

In an example of a preceding example aspect of the device, wherein the plurality of artificial neurons represents a plurality of spiking neurons, each comprising a basal dendrite and an apical dendrite, and wherein the apical dendrite controls whether an event is a burst or a single spike.

In an example of a preceding example aspect of the device, wherein the processing circuitry implements the set of artificial neurons to propagate the feedforward signal through the plurality of feedforward connections associated with the first subset of the plurality of artificial neurons by: mapping the feedforward signal to a query matrix (Q) based on a query weight matrix (Wq); mapping the feedforward signal to a key matrix (K) based on a key weight matrix (Wk); computing a first nested inner product by pairwise multiplication and summation of elements in the key matrix and the query matrix, wherein the first nested inner product represents a somatic input to a QK neuron of the spiking transformer model for generating a spiking output at the QK neuron represented as a QK event train; generating an inhibitory neuron output associated with an inhibitory neuron of the spiking transformer model, based on the QK event trains; mapping the feedforward signal to a value matrix (V) based on a value weight matrix (Wv); and computing a second nested inner product by pairwise multiplication and summation of elements in the value matrix and the inhibitory neuron output, wherein the second nested inner product represents a somatic input to a V neuron of the spiking transformer model for generating a spiking output at the V neuron represented as a V event train.

In an example aspect, the present disclosure describes a non-transitory computer-readable medium having machine-executable instructions stored thereon, the machine-executable instructions, when executed by a processor of a neuromorphic computing device, cause the device to train a spiking transformer model, the spiking transformer model comprising a plurality of artificial neurons and a plurality of artificial synapses, the instructions, when executed by the device, cause the device to perform operations comprising: receiving a first training set including multiple spike trains; and training the spiking transformer model in a first stage using the first training set, wherein training comprises performing a plurality of training iterations for training the spiking transformer model, each training iteration comprising: propagating a feedforward signal through a plurality of feedforward connections of the spiking transformer model, the feedforward connections associated with either a first subset of the plurality of artificial neurons configured to compute a nested inner product (NIP) or a second subset of the plurality of artificial neurons configured to compute a weighted inner product (WIP), to generate a spiking transformer model output; determining a loss based on a comparison of the spiking transformer model output to a target output; encoding the loss in a feedback signal for propagating through a plurality of feedback connections of the spiking transformer model; and updating synaptic weights of the spiking transformer model based on a simultaneous processing of the feedforward signal and the feedback signal using a burst-dependent local learning rule.

In some example aspects, the present disclosure describes a non-transitory computer readable medium storing instructions thereon. The instructions, when executed by a processor, cause the processor to perform any of the preceding example aspects of the method.

### BRIEF DESCRIPTION OF THE DRAWINGS

Reference will now be made, by way of example, to the accompanying drawings which show example embodiments of the present application, and in which:

FIG. 1A is a schematic diagram showing an example representation of a neuronal activation, implemented with a classical integration of a weight inner product (WIP) using a traditional point-like neuron model;

FIG. 1B is a schematic diagram showing an example implementation of a neuronal activation, implemented with a nested inner product using a basal dendritic neuron, in accordance with some embodiments of the present disclosure;

FIG. 2 is a block diagram illustrating an example computing system which may be used to implement examples of the present disclosure;

FIG. 3A shows a block diagram of an example architecture for a spiking transformer network, in accordance with examples of the present disclosure;

FIG. 3B is a schematic diagram showing an example of forward phase information processing in QK neurons, in accordance with examples of the present disclosure;

FIG. 3C is a schematic diagram showing an example of forward phase information processing in V neurons, in accordance with examples of the present disclosure;

FIG. 3D is a schematic diagram showing an example of backward phase information processing in QK neurons, in accordance with examples of the present disclosure;

FIG. 3E is a schematic diagram showing an example of backward phase information processing in V neurons, in accordance with examples of the present disclosure;

FIG. 4 is a flowchart illustrating an example method for training a spiking transformer network, in accordance with examples of the present disclosure.

Similar reference numerals may have been used in different figures to denote similar components.

### DETAILED DESCRIPTION

The following describes example technical solutions of this disclosure with reference to accompanying figures. To assist in understanding the present disclosure, some concepts relevant to neural networks and machine learning (ML) are first discussed.

Machine learning (ML) is an application of artificial intelligence (AI) that provides systems the ability to automatically learn and improve from experience without being explicitly programmed. Generally, an artificial neural network (ANN) comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network, for example, an input layer that accepts inputs, an output layer that generates a prediction as output, and in the case of deep neural networks (DNN), a plurality of hidden layers which are situated between the input layer and output layer. The output of one layer may be provided as input to a subsequent layer. Thus, input to a neural network may be processed through a succession of layers until an output of the neural network is generated by a final layer.

A deep neural network (DNN) is a type of neural network having multiple layers and/or a large number of neurons. The term DNN may encompass any neural network having multiple layers, including convolutional neural networks (CNNs), recurrent neural networks (RNNs), graph neural networks (GNN), and multilayer perceptrons (MLPs), among others. DNNs are often used as ML-based models for modelling complex behaviors in order to improve accuracy of outputs (e.g., more accurate predictions) such as, for example, as compared with models with fewer layers. In the present disclosure, the term machine learning model, or simply “ML model” may be understood to refer to a DNN.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). For example, an attention mechanism represents an attempt to selectively concentrate on fewer relevant things while ignoring other irrelevant things in a DNN by prioritizing and emphasizing relevant information to enhance overall model performance. An example transformer architecture is described in: Vaswani, Ashish, et al. “Attention is all you need.” Advances in neural information processing systems 30 (2017), the entirety of which is hereby incorporated by reference. A transformer architecture may be characterized by the computation of a nested inner product along with a softmax operation.

A spiking neural network (SNN) is a type of neural network that more closely mimics the way biological brains process information. Unlike traditional neural networks that use continuous values and activation functions, SNNs use discrete spikes (electrical impulses) sent at specific times, to transmit information between neurons. In this way, spiking represents a form of neuronal communication in biological and hardware neural networks. For example, a spike can be a binary event, where either a spike occurs or a spike does not occur. Furthermore, information is encoded not just in the presence of spikes, but in their timing and frequency. Spiking neural networks (SNN) are known to be efficient by parallelizing computation and memory, overcoming the memory bottleneck present in other ANNs.

Training of a ML model is a process of learning the values of the parameters (or weights) of the neurons in the layers such that the ML model is able to model the target behavior to a desired degree of accuracy. In the process of training a ML model, two approaches are commonly used: supervised learning and unsupervised learning. In unsupervised learning, the neural network is not provided with any information on desired outputs, and the neural network is trained to arrive at a set of learned weights on its own. In supervised learning, a predicted value outputted by the ML model may be compared to a desired target value (e.g., a ground truth value). A weight vector (which is a vector containing the weights W for a given layer) of each layer of the ML model is updated based on a difference between the predicted value and the desired target value or based on some other objective function (e.g., the minimization of a loss function, or the maximization of a reward, among other possibilities). This comparison and adjustment may be carried out iteratively until a convergence condition is met, for example, a predefined maximum number of iterations has been performed, or the value outputted by the ML model is sufficiently converged with the desired target value or objective function, after which the ML model is considered to be sufficiently trained. The values of the learned parameters may then be fixed and the ML model may be deployed to generate output in real-world applications (also referred to as “inference”).

Training typically requires the use of a training dataset, which is a set of data that is relevant to the target behavior of the ML model. The training data may be a subset of a larger data set. For example, a data set may be split into three mutually exclusive subsets: a training set, a validation (or cross-validation) set, and a testing set and the three subsets of data may be used sequentially during ML model training, or other segmentations of the larger data set and/or schemes for using the segments for training one or more ML models are possible. For example, the training set may be first used to train one or more ML models, for example, where each ML model may have unique characteristics, such as a particular architecture, a particular training procedure, being describable by a set of model hyperparameters, etc. The validation (or cross-validation) set may then be used as input data into the trained ML models to measure the performance of the trained ML models and/or compare performance between them. Once such a trained ML model is obtained, output may be generated using the trained ML model based on the third subset (the testing set), for assessing the accuracy of the trained ML model.

Backpropagation is an algorithm for training a ML model. Backpropagation can be used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Once the ML model is considered to be sufficiently trained, the values of the learned parameters may be fixed and the ML model may be deployed to generate output in real-world applications (also referred to as “inference”). In some examples, a trained ML model may be fine-tuned, meaning that the values of the learned parameters may be adjusted slightly in order for the ML model to better model a specific task. Fine-tuning of a ML model typically involves further training the ML model on a number of data samples that closely target the specific task.

Given that backpropagation relies on continuous-valued activations and differentiable functions, backpropagation can be difficult to implement in SNNs. One existing approach related to training SNNs includes ANN to SNN conversion, for example, enabling an SNN to inherit the performance of an ANN by mapping the ANN to an equivalent SNN. An example approach involving uploading a weight configuration derived from an ANN-to-SNN mapping using a pretrained ANN is described in: Roy, Kaushik, Akhilesh Jaiswal, and Priyadarshini Panda, “Towards spike-based machine intelligence with neuromorphic computing”, Nature 575.7784 (2019): 607-617, the entirety of which is hereby incorporated by reference. In this regard, the weight configuration may be deployed only for inference. An example approach for converting a trained ANN transformer into a spiking transformer is described in: You, Kang, et al., “Spikezip-tf: Conversion is all you need for transformer-based snn”, ar Xiv preprint arXiv: 2406.03470 (2024), the entirety of which is hereby incorporated by reference. Another example approach for converting a trained ANN transformer into a spiking transformer is described in: Jiang, Yizhou, et al., “Spatio-temporal approximation: A training-free snn conversion for transformers”, The twelfth international conference on learning representations. 2024, the entirety of which is hereby incorporated by reference. However, the ANN-to-SNN approach may suffer from poor performance due to inaccuracies of the approximation and of the physical network, and may require further fine-tuning when applied to neuromorphic hardware.

In other approaches, SNNs may be trained with non-local learning rules. For example, the first-order reduced and controlled error (FORCE) learning may be adapted to train SNNs to target tasks by training the readout of a recurrent network with fixed weights. An example approach for adapting the FORCE method to SNNs is described in: Nicola, Wilten, and Claudia Clopath, “Supervised learning in spiking neural networks with FORCE training”, Nature communications 8.1 (2017): 2208, the entirety of which is hereby incorporated by reference. The approach is non-local because all synaptic weights are used in the plasticity rule, for example, learning proceeds by reweighted least-squares which requires knowledge of all connection weights to tune any readout weight. However, this approach may be restricted to RNNs, whereas transformers are feed forward architectures. In another approach, surrogate gradients may approximate non-differentiable spike functions of SNNs during training. For example, an approach where backpropagation through time (BPTT) is performed using a surrogate gradient to enable the calculation of the derivative of the spiking threshold is described in: Neftci, Emre O., Hesham Mostafa, and Friedemann Zenke, “Surrogate gradient learning in spiking neural networks: Bringing the power of gradient-based optimization to spiking neural networks”, IEEE Signal Processing Magazine 36.6 (2019): 51-63, the entirety of which is hereby incorporated by reference. However, BPTT is a non-local learning algorithm which requires detailed storage and replay of activity. In another approach described in: Zhou, Zhaokun, et al., “Spikformer: When spiking neural network meets transformer”, ar Xiv preprint arXiv: 2209.15425 (2022), the entirety of which is hereby incorporated by reference, a SNN is simulated on a neuromorphic hardware and the recorded state variables are uploaded to a simulation of the SNN. This approach offloads the learning to a traditional computer, thereby circumventing learning on neuromorphic chips. Furthermore, the simulation may still require further fine-tuning, thereby exacerbating the reliance on training in traditional computer architectures.

In other approaches, non-spiking models may be trained with local learning rules. For example, while backpropagation is deemed non-local because of the need to perform weight transport, some approaches can approximate backpropagation with local methods, such as rate-based methods. For example, an alternative to backpropagation that adjusts a network's activation to align final output with a desired target is described in: Lee, Dong-Hyun, et al., “Difference target propagation”, Joint European conference on machine learning and knowledge discovery in databases, Cham: Springer International Publishing, 2015, the entirety of which is hereby incorporated by reference. In this method, the alignment signal is communicated instead of the error signal. In another approach utilizing node or weight perturbation described in: Fiete, Ila R., and H. Sebastian Seung, “Gradient learning in spiking neural networks by dynamic perturbation of conductances”, Physical review letters 97.4 (2006): 048104, the entirety of which is hereby incorporated by reference, noise may be injected in the weight or in the node of a network and the correlation between the perturbed activity and the loss may be leveraged to infer changes to the weights based on local information. However, these rate-based approaches have unproven performance in SNNs.

Finally, in some approaches, local learning rules can be used for training SNNs. For example, two-factor Hebbian rules such as STDP can support various tasks without explicit supervision, while three-factor learning rules such as BTSP may improve flexibility by inserting reward information. In other approaches, the use of the apical dendrite of neurons to integrate a supervised error signal for application to spiking networks with the addition of a burst-dependent plasticity rule (BDP) is described in: Payeur, Alexandre, et al. “Burst-dependent synaptic plasticity can coordinate learning in hierarchical circuits.” Nature neuroscience 24.7 (2021): 1010-1019, the entirety of which is hereby incorporated by reference. In this case, dendrite-dependent bursting was used to multiplex feedforward sensory signals with backward error signals (e.g., in high frequency spike trains, such that learning-related information is available locally), however the approach could only be tested on a simple problem (e.g., the XOR task) and is not applicable to more complex tasks, or large networks such as transformers. In another approach, the BDP may be improved through the addition of homeostatic regulation (e.g., firing rate regularization), as described in: Stuck, Michael, Xingyun Wang, and Richard Naud, “A burst-dependent algorithm for neuromorphic on-chip learning of spiking neural networks”, Neuromorphic Computing and Engineering 5.1 (2025): 014010, the entirety of which is hereby incorporated by reference. In this case, the improved BDP approach (referred to herein as “BurstMLP”) enabled the completion of MNIST-type tasks. However, none of the above-described approaches are shown to apply to transformers.

In some embodiments, the present disclosure describes examples that address some or all of the above drawbacks of existing techniques for training spiking transformers.

In the present disclosure, “biological neurons” can mean: building blocks of the nervous system in living organisms. They operate by processing information through the generation of discrete electrical pulses, referred to as spikes or action potentials. The cell body of the neuron is represented by the soma, while dendrites are structural branches on the neurons that collect and process incoming signals. In the context of biological neurons, an “apical dendrite” and a “basal dendrite” can refer to types of dendritic domains associated with a pyramidal neuron, where apical dendrites extend upward from the soma and receive feedback or modulatory inputs, while basal dendrites extend laterally from the base of the soma and typically receive feedforward inputs from nearby neurons. Connections between neurons are represented by synapses. A neuron membrane potential is a voltage difference across a neuron cell membrane, where rapid changes in membrane potential during a spike or action potential generate a signal, enabling communication between neurons.

In the present disclosure, a “spiking network” or a “spiking neural network (SNN)” can mean: a neural network where the communication between two units is made by temporally sparse, binary signals (e.g., spikes), enabling low-power computations, where the timing and frequency of the spikes encodes information.

In the present disclosure, an “attention mechanism” can mean: a mechanism implemented in neural networks (NNs) that enables NNs to selectively focus on the most important parts of input data (e.g., pay attention to certain details). Learned weights associated with more relevant aspects or features are amplified while weights associated with less relevant aspects or features are reduced. The attention mechanism involves three inputs: key (K), query (Q) and value (V), which are typically vector representations or embeddings of the input data (e.g., token embeddings). A dot-product operation between Q and K^{T} (where T is a transpose operation), is followed by a softmax operation to produce an adaptive weight matrix, which indicates how much each token is related to the other tokens. A matrix multiplication between the adaptive weight matrix and V, results in embedding vectors representing tokens from the input sequence and the relationship to the other tokens in the input sequence.

In the present disclosure, “embeddings” can mean: low-dimensional, learned representations of discrete variables as vectors of numeric values. They represent a mapping between discrete variables and a vector of continuous numbers and are learned for neural network models. In some examples, embeddings may be referred to as embedding vectors.

In the present disclosure, a “spiking transformer” can mean: a type of neural network architecture that combines the event-driven processing of SNNs with the contextual modeling of Transformer architectures. For example, a spiking transformer use binary spikes to transmit information, while adapting the Transformer's attention mechanism to the spiking approach.

In the present disclosure, a “von Neumann hardware” can mean: computer systems that follow the Von Neumann architecture and which are characterized by a control unit to manage instruction execution and a shared memory space for both data and instructions. This allows the CPU to fetch instructions and data from the same location for enabling sequential execution (e.g., Instructions are executed one after another). Most common computing devices are based on a von Neuman architecture.

In the present disclosure, a “neuromorphic hardware” or a “neuromorphic computing device” can mean: a biologically-inspired computing hardware based on electronic “neurons” that communicate with one another through spiking sequences (e.g., voltage pulses), in a manner that resembles the spiking sequences of signals between neurons in a human brain. In this regard, a spiking neural network implemented in a neuromorphic hardware may be computationally more efficient than a real-valued neural network because the consumption of resources (e.g., memory, processing power, etc.) required for processing spiking signals (e.g., binary signals) in a neuromorphic hardware is much lower than for processing real-valued signals in traditional von Neumann hardware.

In the present disclosure, a “local learning rule” can mean: a rule used to indicate whether and how weights should be updated (e.g., at a synapse), using only local information available at the synapse (e.g., involving only the pre- and post-synaptic neurons). In examples, the physical factors that determine if a connection should be strengthened or reduced is are available locally and may include features (averages, traces) of the sender unit activity, the receiver unit activity as well as global factors available to all units. In contrast, a rule is considered non-local if, in order to modify one connection, knowledge of the state of all the connections in the network is needed. Similarly, a rule is also considered non-local if, to modify a connection, specific units need to be re-activated in a specific order. In examples, local learning rules may be inspired by biological learning mechanisms.

Other terms used in the present disclosure may be introduced and defined in the following description.

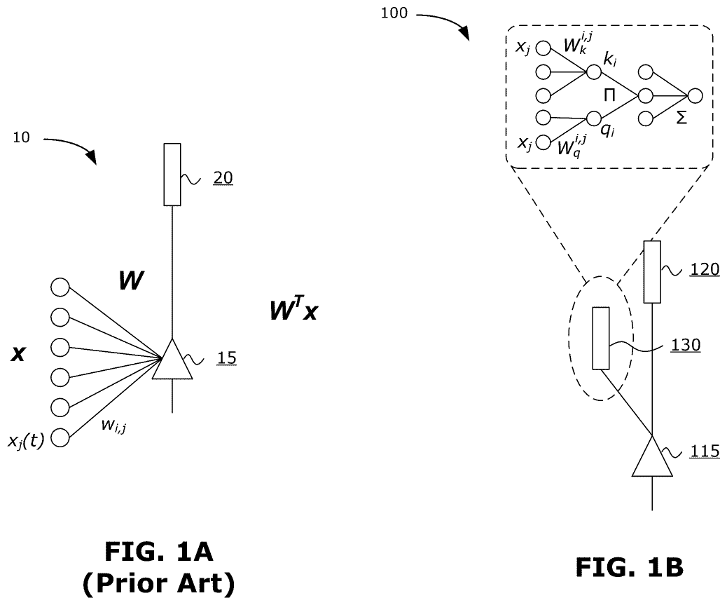

FIG. 1A is a schematic diagram showing an example prior art representation of a neuronal activation, implemented using a classical integration of a weight inner product (WIP) 10 using a traditional point-like neuron model. The point-like neuron model includes a soma 15 and an apical dendrite 20. In examples, the point neuron model computes an inner product (also known as a dot product) of inputs x and synaptic weights W to produce the WIP W^{T}x, where x is an input vector of input signals xⱼ(t) and W is a weight vector of synaptic weights w_{i,j}. The result may then be transformed by an activation function to determine the output.

FIG. 1B is a schematic diagram showing an example implementation of a nested inner product (NIP) using a basal dendritic neuron, in accordance with some embodiments of the present disclosure. The neuron model of FIG. 1B includes a soma 115, an apical dendrite 120 and a basal dendrite 130. In examples, in the context of transformer-based models, a double inner product arises in the attention mechanism between input tokens (e.g., input embeddings X) using:

$$Attention ( Q , K , V ) = softmax ( \frac{{K}^{T} Q}{\sqrt{d}} ) V \qquad ( 1 )$$

where K represents a key matrix, Q represents a query matrix and V represents a value matrix and d is a scaling factor. In examples, K, Q and V are each obtained using an inner product of weights and tokens, for example,

$$K = {W}_{k}^{T} X , Q = {W}_{q}^{T} X$$

$$and$$

$$V = {W}_{v}^{T} X .$$

In this regard, the attention mechanism involves a NIP in that K^{T}Q involves multiple inner products between key and query vectors.

For example, a first step in the self-attention mechanism can be represented by:

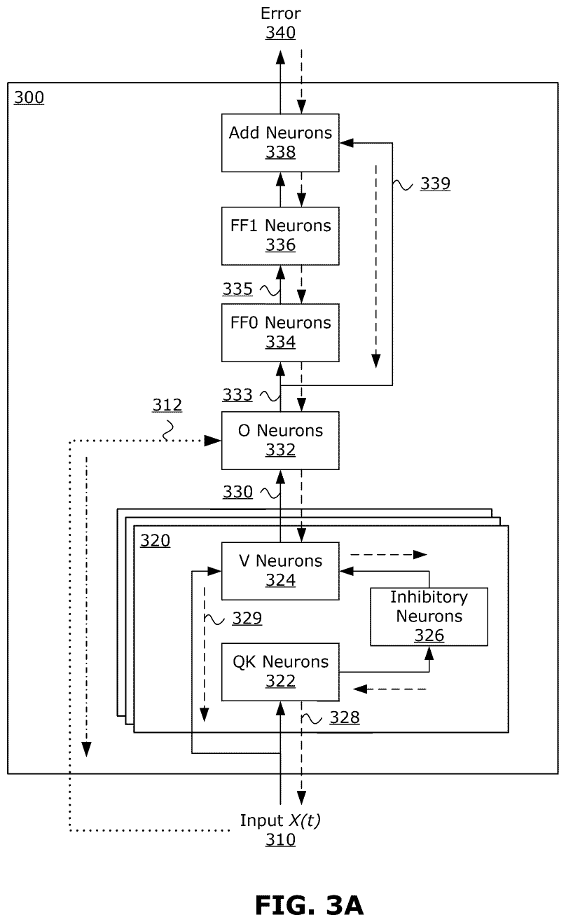

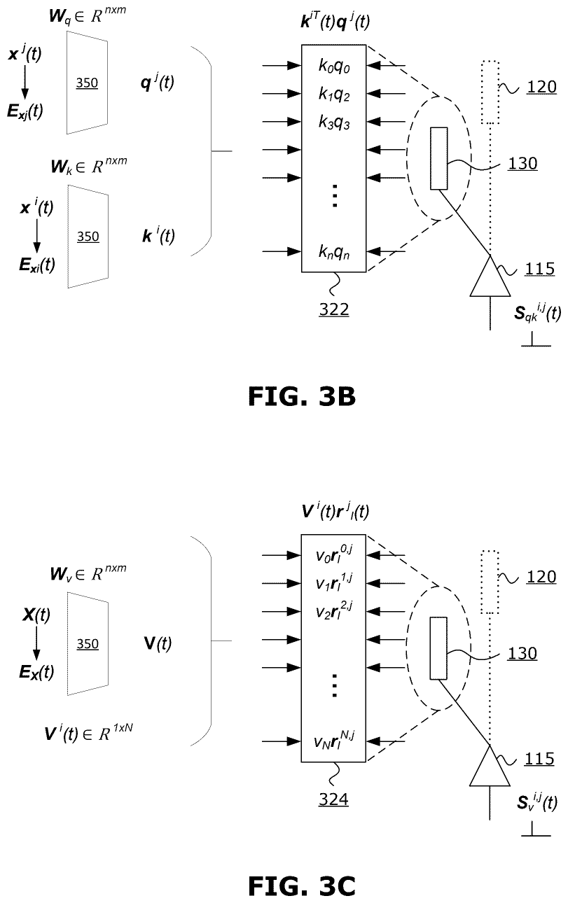

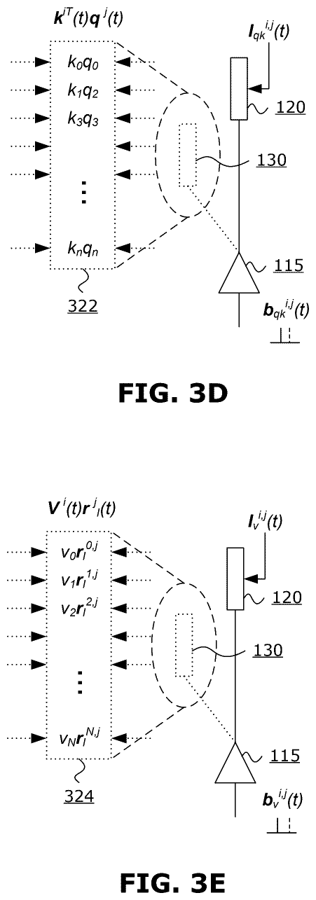

K^{T}Q≡(WₖX)^{T}(W_{q}X) (2)

where Wₖ and W_{q} are weight matrices and X is the input matrix. In some embodiments, for example, the inner product W_{q}X may be represented as a weighted sum of inputs to a neuron using the classical WIP illustrated in FIG. 1A. In examples, the computation of K^{T}Q further involves a second layer of inner product represented by WₖX. In this regard, the second inner product may be modeled as occurring at a basal dendrite 130, as shown in FIG. 1B and further described with respect to FIGS. 3B and 3C.

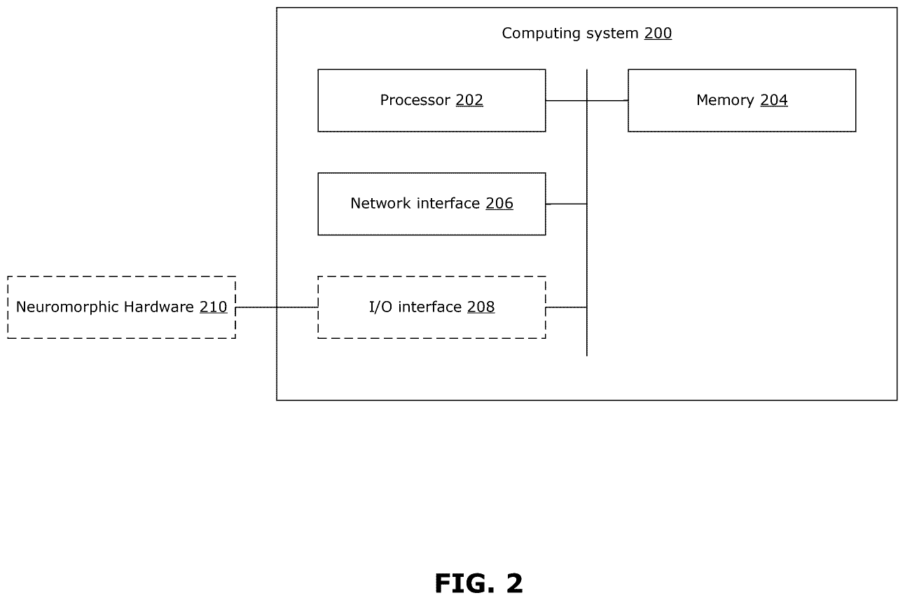

FIG. 2 is a block diagram illustrating a simplified example implementation of a computing system 200 that is suitable for implementing embodiments described herein or which may be used in conjunction with embodiments described herein. In some implementations, computing system 200 can be a neuromorphic computing system, or the computing system 200 can be an electronic computing device, such as a networked server or a single computer. Other examples suitable for implementing implementations described in the present disclosure can be used, which can include components different from those discussed below. Although FIG. 2 shows a single instance of each component, there can be multiple instances of each component in the computing system 200. The computing system 200 may be used to execute instructions for training a spiking transformer, using any of the examples described above. The computing system 200 may also be used to execute the trained neural network model, or the trained neural network model may be executed by another computing system.

The computing system 200 includes at least one processing unit (which may have one or more processing cores), and at least one physical memory 204. The processing unit may be a hardware processor 202 (simply referred to as processor 202). The processor 202 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, such as to carry out examples described in the present disclosure. In examples, the memory 204 may store instructions for implementing any of the neural networks and methods disclosed herein. For example, the memory 204 may include instructions, executable by the processor 202, to train the spiking transformer network 300 as described with respect to FIG. 3 below. The memory 204 may include other software instructions, such as for implementing an operating system and other applications/functions. The memory 204 may also include data, such as model training data or trained parameters (e.g., weight values) of a neural network, among other possibilities.

The computing system 200 may include one or more network interfaces (collectively referred to as network interface 206) for wired or wireless communication with a network (e.g., an intranet, the Internet, a P2P network, a WAN and/or a LAN) or another node. The network interface 206 may include wired links (e.g., Ethernet cable) and/or wireless links (e.g., one or more antennas).

The computing system 200 may include an input/output (I/O) interface 208, which may interface with input device(s) and/or output device(s) (not shown). Input device(s) may include, for example, buttons, a camera, a microphone, a touchscreen, a keyboard, etc. Output device(s) may include, for example, a display, a speaker, etc. In examples, optional input device(s) and optional output device(s) may be external to the computing system 200, or in other examples, one or more of the optional input device(s) and/or optional output device(s) may be an internal component of the computing system 200.

The computing system 200 may include a neuromorphic hardware 210. For example, the neuromorphic hardware 210 may be a neuromorphic chip associated with an electronic device. In some embodiments, for example, the neuromorphic hardware 210 may represent a neuromorphic chip for performing computer vision tasks in an autonomous driving car, among other possibilities. In other embodiments, for example, the neuromorphic hardware 210 may represent a neuromorphic chip for performing speech processing tasks in an electronic device, such as a smart phone, among other possibilities. In examples, the computing system 200 may be configured to cooperate with the neuromorphic hardware 210, for example, instructions stored in the memory 204 may cause the computing system 200 to function as or perform operations associated with the neuromorphic hardware 210, or to perform processes of the embodiments disclosed herein. In other examples, the neuromorphic hardware 210 may be configured to accept as inputs, data from one or more sources (e.g., servers, datastores etc.) associated with the computing system 200. In some examples, a neuromorphic hardware 210 may include a processor that is structured to mimic certain aspects of the brain (e.g., neurons and the interconnections between the neurons). In some embodiments, for example, a processor of the neuromorphic hardware 210 may comprise a plurality of interconnected neuromorphic cores that may be interconnected via a network architecture (e.g., a bus or routing devices) to enable communication between the cores. In examples, the neuromorphic hardware 210 may implement a SNN or another spiking model (such as the spiking transformer network 300 as described with respect to FIG. 3) in the plurality of neuromorphic cores, where neuromorphic cores may implement neurons that are collocated with synapse memory blocks to hold synapse weights to overcome bottlenecks associated with von Neumann hardware.

In some examples, the computing system 200 may also include an electronic storage unit (not shown), such as a solid state drive, a hard disk drive, a magnetic disk drive and/or an optical disk drive. In some examples, data and/or instructions may be provided by an external memory (e.g., an external drive in wired or wireless communication with the computing system 200) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computing system 200 may communicate with each other via a bus, for example.

FIG. 3A shows a block diagram of an example online learning architecture for the spiking transformer network 300 in which the network both infers and learns for each input timing t, in accordance with examples of the present disclosure. The forward information flow is shown in FIG. 3A with solid arrows and the backward information flow is shown with dashed arrows. The spiking transformer network 300 may be software that is implemented on a neuromorphic hardware 210, for example, for on-chip learning. In other embodiments, for example, the computing system 200 may be a neuromorphic computing system and the spiking transformer network 300 may be software that is implemented in the computing system 200 of FIG. 2, in which the processor 202 is configured to execute instructions of the spiking transformer network 300 stored in the memory 204. The spiking transformer network 300 in this example includes one or more attention heads 320, where a nested inner product (NIP) is implemented in QK neurons 322 and V neurons 324 of the one or more attention heads 320 and a weight inner product (WIP) is implemented through a sequence of neurons including O neurons 332, FF0 neurons 334, FF1 neurons 336 and Add neurons 338.

In examples, a spiking input signal X(t) (e.g., input 310) may be provided to the spiking transformer network 300. In examples, the spiking input signal X(t) may correspond to a sequence of tokens or input embeddings, for example, the input signal may be a spiking input comprising sequential spike trains unfolding on time t for a forward pass of the network, where continuous-valued token embeddings have been converted to spike trains using an encoding scheme, such as a biologically inspired encoding scheme, among other possibilities. The input signal X at time t is shown in equation 3:

X(t)=[x⁰,x¹,x², . . . ,x^{j}, . . . ,x^{N}],∈ [symbol] ^{m×N} (3)

where m represents the dimensions of the input and N represents the length of the sequence (e.g., the number of tokens). In examples, during a forward phase the input 310 may be received by QK neurons 322 of the spiking transformer network 300.

FIG. 3B is a schematic diagram showing an example of forward phase information processing in the QK neurons 322, in accordance with examples of the present disclosure. In examples, a temporal filter 350 (e.g., an exponential decay function, among other possibilities) may be applied to incoming spikes of the input signal X(t) at the QK neurons 322 to create a continuous signal that reflects the recent history of spiking activity in the neuron, for example, as an eligibility trace Eₓ(t) of the spiking inputs. For example, signals from the jth token and the ith token in the input signal X(t) may be filtered to generate Eₓⱼ(t) and Eₓᵢ(t), respectively. In examples, the filtered input signal can accumulate when spikes occur while decaying over time when no spikes are present. In this regard, eligibility can be used to gate learning when combined with a modulatory signal (e.g., feedback or reward), as described with respect to FIGS. 3D-E below.

In examples, a synaptic weight matrix W_{q}∈ [symbol] ^{n×m} may be used to map the input X(t) into a query matrix Q(t) at time t using equation 4:

Q(t)=W_{q}X(t),∈ [symbol] ^{n×N} (4)

where n represents the number of queries. Similarly, a key weight matrix W∈ [symbol] ^{n×m} may be used to map the input X(t) into a key matrix K(t) at time t using equation 5:

K(t)=WₖX(t),∈ [symbol] ^{n×N} (5)

In examples, for computing the NIP, signals from the jth token in the query matrix q^{j}(t) and ith token in the key matrix kⁱ(t) may be projected into same basal dendrite as shown in FIG. 3B. In examples, qⁱ(t) and kⁱ(t) may represent local dendritic potentials on the same branch of the basal dendrite 130 and the elements in k and q may be pairwise multiplied and summed to generate a first inner product k^{T}q. In this regard, the first inner product k^{T}q represents a somatic input to soma 115 from the basal dendrite 130 of the QK neuron 322, which is used to update the soma's potential for generating a spike using the leaky integrate-and-fire (LIF) spiking process. In examples, the soma's potential Vs is updated as shown in equation 6:

$$Δ {V}_{s} = - \frac{{V}_{s}}{{τ}_{s}} Δ t + {k}^{T} q \qquad ( 6 )$$

In the spiking process, a spike will be triggered when the soma's potential Vs reaches a threshold Vₜₕᵣₑₛ. For the QK neurons 322 the process is

$$Δ {V}_{s} = - \frac{{v}_{s}}{{τ}_{s}} Δ t + {K}^{T} Q$$

the final spiking output of QK neurons 322 may be event trains S_{qk}(t)∈ [symbol] ^{N×N}.

Returning to FIG. 3A, the event trains S_{qk}(t) may be received at the inhibitory neurons 326. In examples, the event trains may be converted into an exponentially smoothed version (e.g., using a temporal filter 350, among other possibilities) to generate an eligibility trace E(t)∈ [symbol] ^{N×N} at the inhibitory neurons 326. In examples, the inhibitory neurons 326 may be considered to perform an integrative process for capturing the effect of common divisive inhibition, for example, to enable implementing a softmax operation along the dimension of the keys. An example of an integrative process for capturing the effect of common divisive inhibition that can be implemented in example embodiments is described in: Fukai, Tomoki, and Shigeru Tanaka, “A simple neural network exhibiting selective activation of neuronal ensembles: from winner-take-all to winners-share-all”, Neural computation 9.1 (1997): 77-97, the entirety of which is hereby incorporated by reference. For example, for a single inhibitory neuron, the inhibitory neurons 326 may separately receive a sum of the keys to form a summed E(t)∈ [symbol] ^{N×1}, along with the input from one QK neuron 322 to form an eligibility trace E^{i,j} for the output from the one QK neuron. In examples, E^{i,j} may be used to generate a corresponding output

$${r}_{I}^{i , j}$$

according to equation 7:

$${r}_{I}^{i , j} = \frac{{e}^{{E}^{i , j}}}{{\sum }_{i} {e}^{{E}^{i , j}}} \qquad ( 7 )$$

where the output of the inhibitory neurons 326 is

$${r}_{I}^{i , j} ∈ {ℜ}^{N \times N} .$$

In examples, the output of the inhibitory neurons 326 is provided to V neurons 324. The V neurons 324 also receive input X(t) 310 for computing the NIP, as described with respect to FIG. 3C.

FIG. 3C is a schematic diagram showing an example of forward phase information processing in V neurons 324, in accordance with examples of the present disclosure. In examples, the temporal filter 350 may also be applied to the input signal X(t) to generate an eligibility trace Eₓ(t) at the V neuron. In examples, the value weight matrix W_{ν}∈ [symbol] ^{n×m} may be used to map the input X(t) into a value matrix V(t) at time t using equation 8:

V(t)=W_{ν}X(t),∈ [symbol] ^{n×N} (8)

In examples, for computing the NIP, signals from the value matrix V(t) and the output from the inhibitory neurons 326 may be projected into same basal dendrite (e.g., having the same dimension as the basal dendrite 130 described with respect to FIG. 3B). In examples, for a single V neuron i, local dendritic potentials on the basal dendrite 130 may be Vⁱ∈ [symbol] ^{1×N} and are gated by

$${r}_{I}^{j} ∈ {ℜ}^{N \times 1}$$

(e.g., from the inhibitory neurons 326). In examples, for a single V neuron i, the somatic input to soma 115 from the basal dendrite 130 of the V neuron 324 is used to update the soma potential (for generating a spike) of the single V neuron i, as shown in equation 9:

$${V}^{i} {r}_{I}^{j} ∈ ℜ \qquad ( 9 )$$

In the spiking process, a spike will be triggered when the soma's potential reaches a threshold Vₜₕᵣₑₛ. The final spiking output of V neurons 324 may be S_{ν}∈S^{n×N}, where S∈{0,1}. The process described above with respect to V neurons 324 only represents one attention head (e.g., of the multiple model heads 320 shown in FIG. 3A), therefore for implementation using multiple heads, multi-head spiking outputs from V neurons

$${S}_{v}^{h} ∈ {S}^{nxNxh} ,$$

may be merged to generate a merged output 330.

Returning to FIG. 3A, the merged output 330 may be received by the O neurons 332, where the merging is performed using Wₒ∈ [symbol] ^{h×1}, as shown in equation 10:

$$O = {S}_{v}^{h} {W}_{o} ∈ {ℜ}^{n \times N} \qquad ( 10 )$$

where h represents the number of heads, and where the tensor operation is defined as the inner product between the final dimension of

$${S}_{v}^{h}$$

and the first dimension of Wₒ.

In examples, for each single O neuron 332, it's dendritic potential O^{i,j}∈ [symbol] is added with another dendritic potential

$${X}_{I 0}^{i , j} ∈ ℜ$$

to generate the somatic input for updating the soma's potential for the spiking process, for example, where the spiking output of the O neurons 332 is represented by Sₒ∈S^{n×N×1}. In examples, gap connections Wₗₒ 312 (e.g., shown as dotted lines in FIG. 3A) may be set to zeros and may be frozen during training, for example, ensuring that only the attention mechanism is used to solve tasks.

In examples, two feedforward layers (e.g., FF0 neurons 334 and FF1 neurons 336) follow, where information processing in FF0 neurons 334 and FF1 neurons 336 are provided in equations 11 and 12, respectively:

S_{FF0}=Spk(X_{FF0})∈S^{n×N},X_{FF0}=W_{FF0}S_{O}∈ [symbol] ^{n×N} (11)

S_{FF1}=Spk(X_{FF1})∈S^{n×N},X_{FF1}=W_{FF1}S_{FF0}∈ [symbol] ^{n×N} (12)

where S_{FF0} and S_{FF1} represent the dendritic output (e.g., event trains) for the FF0 neurons 334 and FF1 neurons 336, respectively and Spk represents the LIF process for generating events (see equation 6). In examples, the LIF process can map the somatic potentials X_{FF0} and X_{FF1} on to event trains S_{FF0} and S_{FF1}, respectively, based on W_{FF0} 333 and W_{FF1} 335.

In examples, a further layer represented by Add Neurons 338 is included in the spiking transformer network 300 for generating a further event train S_{add} by adding the S_{FF1} event trains with a somatic action potential Xu associated with further gap connection Wu 339, as described in equation 13:

S_{add}=Spk(S_{FF1}+Xₗ₁)∈S^{n×N},Xₗ₁=Wₗ₁S₀∈ [symbol] ^{n×N} (13)

In examples, for each add neuron 338, the dendritic input

$${S}_{FF 1}^{i , j} ∈ \{ 0 , 1 \}$$

is summed with

$${X}_{I 1}^{i , j} ∈ {ℜ}^{n X N}$$

to obtain the final spiking output as event train S_{add}, for example, associated with the forward pass of the spiking transformer network 300. In examples, a temporary filter may be applied to the event train S_{add} (e.g., to smooth it or convert it into a continuous signal) to obtain an instantaneous rate r_{add}(t). In examples, the instantaneous rate r_{add}(t) may be a time-varying signal that represents the rate of spiking at each time step. An error 340, for example, denoted by a loss function L(t), is computed as the mean squared error (MSE) between the target rate rₜₐᵣ(t) and the instantaneous rate. During supervised learning, the target rate functions as labeled training data, where the target rate rₜₐᵣ(t) is generated by transforming original class labels into one-hot encoded vectors, which are then mapped onto a neural population based on firing activity. The magnitude of the firing activity may be scaled by a tunable hyperparameter to control the firing intensity.

In some embodiments, for example, during a backwards phase, the information flow through the spiking transformer network 300 follows the dashed arrows in FIG. 3A. In examples, for updating weight matrices in the spiking transformer network 300, neuronal or burst multiplexing is leveraged for communicating both the feedforward signals (e.g., with the event rate, such as the rate of either single spikes or bursts, computed from the event trains S_{qk}, Sᵥ, etc.) and the feedback signals (e.g., with the burst rate, where bursts represent at least two spikes with very short inter-spike interval). In examples, the neuronal multiplexing is achieved by ensuring an unambiguous separation between bursts and single spikes. For example, separating between bursts and spikes may be achieved by various approaches, such as a marked point process, or by inserting a second spike within the absolute refractory period of a LIF model, among other possibilities. FIGS. 3D and 3E provide a schematic diagram showing an example of backward phase information processing in QK neurons 322, and V neurons 324, respectively, in accordance with examples of the present disclosure.

In examples, a burst-dependent learning rule and burst-dependent signal processing are used to orchestrate the flow of error signals (e.g., as feedback signals) through the spiking transformer network 300. Specifically, the incorporation of apical dendritic processing (e.g., which controls whether an event is a burst or a single spike) into neuronal layers of the spiking transformer network 300 enables the conveyance of neuron-specific error signals from the layer above. To update weight matrices in the spiking transformer network 300, the above described neuronal multiplexing ability is leveraged to communicate the feature signal as the event rate and the error signal as the burst fraction. Accordingly, weight change rules ΔWₗ(t) for various layers having a weighted inner product (e.g., Add neurons 338, FF1 neurons 336, FF0 neurons 334) may be determined using the burst-dependent plasticity rule provided in equation 14:

$$Δ {W}_{l} ( t ) = η {b}_{l} ( t ) {E}_{l - 1}^{T} ( t ) \qquad ( 14 )$$

where bₗ(t) represents the burst train (e.g., instantaneous burst rate) of the current layer l neurons, Eₗ₋₁(t) represents the pre-synaptic eligibility trace of the current layer's neurons (e.g., arising from events in the layer below), and n represents the learning rate, where a learning rate may be a scalar parameter that controls the magnitude of weight updates, effectively scaling the effect of the local learning rule, regardless of which rule is used. In some embodiments, for example, an input I to the apical dendrite for the layer l is desired such that

$${b}_{l} ∝ - \frac{\partial L ( t )}{\partial {S}_{l ( t )}} .$$

In examples, bursts may be generated by integrating the apical input as in equation 15:

$$Δ {V}_{d} = - \frac{{V}_{d}}{{τ}_{d}} Δ t + {I}_{l} \qquad ( 15 )$$

where V_{d} is the dendritic action potential at the apical dendrite at time t, which integrates inputs and leaks away with time constant τ_{d}, and Iₗ represents an apical dendritic input for layer l (e.g., as determined using equations 18, 20-22 below). An example approach for integrating the apical input is described in: Stuck, Michael, Xingyun Wang, and Richard Naud, “A burst-dependent algorithm for neuromorphic on-chip learning of spiking neural networks”, Neuromorphic Computing and Engineering 5.1 (2025): 014010, the entirety of which is hereby incorporated by reference.

In examples, the burst train may then be generated according to a burst probability pₗ(t) as shown in equation 16:

pₗ(t)=|tanh(V_{d}(t))| (16)

where tanh represents a sigmoidal activation function that maps V_{d} into to the interval (−1,1). Furthermore, bursts may be generated using the signed burst method as shown in equation 17:

bₗ(t)=sign(V_{d})⊙pₗ(t)⊙eₗ(t) (17)

where eₗ(t) represents the event (e.g., the event train Sₗ). In examples, when a positive error is observed, such that the target rate is larger than the instantaneous rate, a positive burst may be generated. Similarly, when a negative error is observed, such that the target rate is smaller than the instantaneous rate, a negative burst may be generated.

In some implementations, the burst train bₗ(t) can arise from a Monte Carlo method for generating a discrete signal. For example, after sampling a random number in a uniform distribution [0,1] for each neuron layer and time step t, if the random number is smaller than the burst probability pₗ(t) for the layer l, and there exists an event Sₗ(t) at that time (t), then a burst will be generated. In examples, if a burst is generated, the sign of V_{d}(t) (e.g., V_{d}(t)<0 or V_{d}(t)>0) may be used to determine its burst type, for example, a short burst (e.g., negative burst) or a long burst (e.g., positive burst), among other possibilities. In this way, the burst train may be simulated as a marked point process with different labels (+/−) depending on the sign of the backward error. For example, this can be embodied in a binary spike train by separating two different types bursting patterns such as short bursts and long bursts, among other possibilities.

In some implementations, given that the probability of burst generation depends on the apical dendrite potential (which is determined by apical inputs Iₗ), derivatives of the final loss L(t) 340 for time step t with respect to the weight matrices are provided in equation 18, for example, for the purpose of establishing a dependence on apical inputs Iₗ. For exemplary purposes, equation 18 is provided for Add neurons 338, however the approach can be applied to other neuron layers, such as FF1 neurons 336, FF0 neurons 334, O neurons 332, V neurons 324 and QK neurons 332, among other possibilities.

$$\frac{\partial L ( t )}{\partial {S}_{add} ( t )} = \frac{\partial MSE ( {r}_{tar} , {r}_{add} )}{\partial {r}_{add}} ∝ - ( {r}_{tar} ( t ) - {r}_{add} ( t ) ) \qquad ( 18 )$$

In examples, to uphold that

$${b}_{add} ( t ) ∝ - \frac{\partial L ( t )}{\partial {S}_{add} ( t )} ,$$

the apical input (e.g., I_{add} shown for the Add neuron 338) can be set according to equation 19:

I_{add}=(rₜₐᵣ(t)−r_{add}(t)) (19)

where rₜₐᵣ(t) represents the target rate and r_{add}(t) represents an instantaneous event rate corresponding to the neuronal layer, in this example, obtained for the event train S_{add} for Add neuron 238, for example, during the forward pass.

In examples, to prevent the firing rate from vanishing or exploding, a local error is defined as in equation 19. An example approach for determining a local error is described in: Stuck, Michael, Xingyun Wang, and Richard Naud, “A burst-dependent algorithm for neuromorphic on-chip learning of spiking neural networks”, Neuromorphic Computing and Engineering 5.1 (2025): 014010, the entirety of which is hereby incorporated by reference.

error_{local}=(r₀−rₗ(t) (20)

where rₒ is a global firing rate target and rₗ(t) represents the instantaneous event rate for the neuronal layer l. In examples, the local error signal may be added to the feedback error, for example, for supporting a trade off in the SNN between performance and the model homeostatic firing rate target (e.g., rₜₐᵣ(t)). In examples, the feedback error is communicated via the burst train bₗ₊₁ (e.g., corresponding to the layer above), thereby ensuring that all communication between neurons is spiking. In examples, the inputs to the apical dendrites for the remaining neuronal layers in the spiking transformer network 300 are provided in equations 21-23:

$${I}_{FF 1} = {b}_{add} ( t ) + {error}_{local} , {I}_{FF 0} = {W}_{FF 1}^{T} {b}_{FF 1} ( t ) + {error}_{local} \qquad ( 21 )$$

$${I}_{O} = {W}_{FF 0}^{T} {b}_{FF 0} ( t ) + {W}_{l 1}^{T} {b}_{add} ( t ) + {error}_{local} \qquad ( 22 )$$

$$\begin{matrix}{I}_{v} = {b}_{O} ( t ) {W}_{O}^{T} + {error}_{local} , {I}_{qk} = \frac{\partial {r}_{I}}{\partial {S}_{qk}} {V}^{T} ( t ) {b}_{v} ( t ) + {error}_{local} & ( 23 )\end{matrix}$$

In examples, based on the provided burst generation mechanism, the weight change of the weighted inner product (WIP) layers in the spiking transformer network 300 (e.g., FF0 neurons 334, FF1 neurons 336 and Add neurons 338) follows the burst-dependency learning rule (e.g., provided in equation 14). Accordingly, weight change rules can be derived for Wₗ₁ 339, W_{FF1} 335, and WFF. 333, as shown in equations 24-25:

$$Δ {W}_{l 1} = η {b}_{add} ( t ) {E}_{o}^{T} ( t ) ∈ {ℜ}^{nxn} , Δ {W}_{FF 1} = η {b}_{FF 1} ( t ) {E}_{FF 0}^{T} ( t ) ∈ {ℜ}^{nxn} \qquad ( 24 )$$

$$\begin{matrix}Δ {W}_{FF 0} = η {b}_{FF 0} ( t ) {E}_{o}^{T} ( t ) ∈ {ℜ}^{nxn} & ( 25 )\end{matrix}$$

Furthermore, the weight change associated with Wₒ 330 and Wₗₒ 312 can be derived as shown in equation 26, where the

$${E}_{v}^{h} ( t ) ∈ {ℜ}^{nxNxh}$$

and bₒ(t)∈ [symbol] ^{n×N×1} operations between tensors are defined to sum weight changes across neurons and tokens to update weights of multi-head merging:

$$Δ {W}_{o} = η {E}_{v}^{h} ( t ) {b}_{o} ( t ) ∈ {ℜ}^{hx 1} , Δ {W}_{l 0} = η {b}_{l 0} ( t ) {E}_{X}^{T} ( t ) ∈ {ℜ}^{nxm} \qquad ( 26 )$$

In examples, the weight change of each nested inner product (NIP) layer in the spiking transformer network 300 can be derived for W_{ν} 329, W_{q} and Wₖ as shown in equations 27-28:

$$Δ {W}_{v} = η {b}_{v} ( t ) {r}_{I}^{T} ( t ) {E}_{X}^{T} ( t ) ∈ {ℜ}^{nxm} \qquad ( 27 )$$

$$Δ {W}_{q} = η K ( t ) {b}_{qk} ( t ) {E}_{X}^{T} ( t ) ∈ {ℜ}^{nxm} , Δ {W}_{k} = {η ( {b}_{qk} ( t ) {Q}^{T} ( t ) )}^{T} {E}_{X}^{T} ( t ) ∈ {ℜ}^{nxm} \qquad ( 28 )$$

In some embodiments, for example, the derivation of local learning rules as described herein enables an error signal b(t) as a digital signal that communicates backwards through the spiking transformer network 300 using a feedback weight W^{T} to the previous layer as W^{T}b(t). In this regard, the communication of the digital error signal b(t) supports on-chip learning of transformer architectures on neuromorphic hardware.

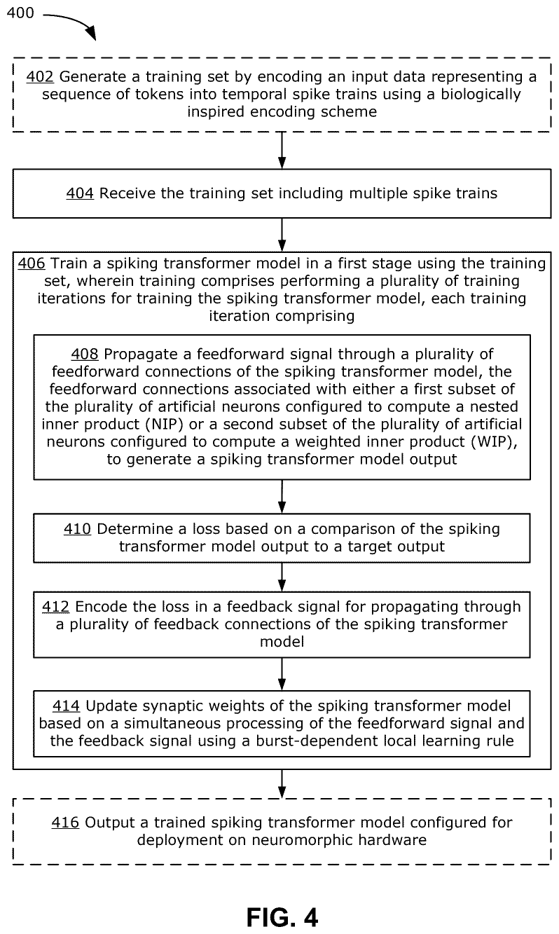

FIG. 4 is a flowchart illustrating an example method 400 for training a spiking transformer network 300 on-chip, in accordance with examples of the present disclosure. The method 400 may be performed by the neuromorphic hardware 210. For example, a processor of the neuromorphic hardware 210 may execute instructions stored in a memory of the neuromorphic hardware 210, to cause the neuromorphic hardware 210 to perform the method 400. In other embodiments, the method 400 may be performed by the computing system 200, for example, the processor 202 may execute computer readable instructions (which may be stored in the memory 204) to cause the computing system 200 to perform the method 400.

Method 400 begins with step 402, in which a training data set is generated by encoding an input data representing a sequence of tokens into temporal spike trains using a biologically inspired encoding scheme.

At step 404, the training data set including multiple spike trains may be received.

At step 406, the spiking transformer model may be trained in a first stage using the training set. In examples the training may be implemented on a neuromorphic chip, among other possibilities. In examples, the training process may include performing a plurality of training iterations, with each training iteration comprising the following operations 408-414.

At step 408, a feedforward signal may be propagated through a plurality of feedforward connections of the spiking transformer network 300. In examples, the feedforward signal may represent a signal that is encoded with rates of spikes or the feedforward signal may represent a signal that is encoded with time to first spike (TTFS) encoding, among other possibilities. For example, the feedforward signal may be coded with time delay for the first spike to arrive. Using this approach, feedforward (and feedback) signals may be coded in distinct phases. In examples, the feedforward connections may be associated with either a first subset of the plurality of artificial neurons (e.g., QK neurons 322, V neurons 324 and inhibitory neurons 326) configured to compute a nested inner product (NIP) or a second subset of the plurality of artificial neurons (e.g., O neurons 332, FF0 neurons 334, FF1 neurons 336 and Add neurons 338) configured to compute a weighted inner product (WIP), to generate a spiking transformer network output.

In some examples, propagating the feedforward signal through the plurality of feedforward connections associated with the first subset of the plurality of artificial neurons may include mapping the feedforward signal to a query matrix (Q) based on a query weight matrix (W_{q}), mapping the feedforward signal to a key matrix (K) based on a key weight matrix (Wₖ) and computing a first nested inner product by pairwise multiplication and summation of elements in the key matrix and the query matrix, wherein the first nested inner product represents a somatic input to a QK neuron 322 of the spiking transformer network 300 for generating a spiking output at the QK neuron 322, for example, represented as an event train S_{qk}. In examples, propagating the feedforward signal through the plurality of feedforward connections associated with the first subset of the plurality of artificial neurons may further include generating an inhibitory neuron output associated with an inhibitory neuron 326 of the spiking transformer network 300, based on the QK event trains, mapping the feedforward signal to a value matrix (V) based on a value weight matrix (Wᵥ) and computing a second nested inner product by pairwise multiplication and summation of elements in the value matrix and the inhibitory neuron output, wherein the second nested inner product represents a somatic input to a V neuron 324 of the spiking transformer network 300 for generating a spiking output at the V neuron, for example, represented as an event train Sᵥ.

At step 410, a loss L(t) may be determined based on a comparison of the spiking transformer network output to a target output. In examples, the spiking transformer model output may represent an instantaneous event rate, and the target output may represent a target event rate.

At step 412, the loss L(t) may be encoded in a feedback signal for propagating through a plurality of feedback connections of the spiking transformer network 300. For example, the feedback signal may represent a signal that is encoded with rates of bursts or the feedback signal may represent a signal that is encoded with time to first spike (TTFS) encoding, among other possibilities.

At step 414, synaptic weights of the spiking transformer network 300 may be updated based on a simultaneous processing of the feedforward signal and the feedback signal using a burst-dependent learning rule. For example, the plurality of artificial neurons may represent a plurality of spiking neurons, where each spiking neuron includes a basal dendrite and an apical dendrite. In examples, updating the synaptic weights may include receiving the feedback signal Iₗ(t) at an apical dendrite of a current artificial neuron layer l, receiving an eligibility trace Eₗ₋₁(t) associated with a previous artificial neuron layer l−1 and updating a synaptic weight matrix of the current artificial neuron layer l when the burst-dependent local learning rule indicates that the feedback signal satisfies a gating condition for plasticity associated with the current artificial neuron. In examples, the burst-dependent local learning rule may be determined as described with respect to equation 14, for example, based on the received feedback signal, the eligibility trace and a pre-determined learning rate.

For example, according to this approach, a synapse may become eligible for plasticity (e.g., updating of synaptic weights) when a feedforward (pre-synaptic) signal arrives at the neuron, the neuron's membrane potential is at a certain level (e.g., represented by the eligibility trace) and a feedback (post-synaptic) signal indicating feedback or error arrives at the neuron, for example, as a burst signal via the apical dendrite. In this regard, only when these conditions are met does the synapse become eligible for updating the synaptic weights. In this regard, the burst-dependent local learning rule determines whether and how to update the synaptic weight. In indicating when the neuron is eligible for plasticity, the local learning rule can serve to gate learning, for example, when combined with a modulatory signal such as the feedback signal.

At step 416, a trained spiking transformer network 300 may be output, where the trained spiking transformer network 300 may be configured for deployment on neuromorphic hardware.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration in-formation, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method for training a spiking transformer model on a neuromorphic computing device, the spiking transformer model comprising a plurality of artificial neurons and a plurality of artificial synapses, the method comprising:
receiving a training set including multiple spike trains; and
training the spiking transformer model in a first stage using the first training set, wherein training comprises performing a plurality of training iterations for training the spiking transformer model, each training iteration comprising:
propagating a feedforward signal through a plurality of feedforward connections of the spiking transformer model, the feedforward connections associated with either a first subset of the plurality of artificial neurons configured to compute a nested inner product (NIP) or a second subset of the plurality of artificial neurons configured to compute a weighted inner product (WIP), to generate a spiking transformer model output;
determining a loss based on a comparison of the spiking transformer model output to a target output;
encoding the loss in a feedback signal for propagating through a plurality of feedback connections of the spiking transformer model; and
updating synaptic weights of the spiking transformer model based on a simultaneous processing of the feedforward signal and the feedback signal using a burst-dependent local learning rule.

2. The method of claim 1, further comprising:
obtaining a set of trained model parameters, the model parameters having been generated according to the method of claim 1.

3. The method of claim 1, wherein the training is implemented on a neuromorphic chip.

4. The method of claim 1, wherein the feedforward signal is encoded with rates of spikes and the feedback signal is encoded with rates of bursts.

5. The method of claim 1, wherein the feedforward signal and the feedback signal are encoded with time to first spike (TTFS) encoding.

6. The method of claim 1, wherein feedforward connections and feedback connections are communicated via burst multiplexing.

7. The method of claim 1, wherein the plurality of artificial neurons represents a plurality of spiking neurons, each comprising a basal dendrite and an apical dendrite.

8. The method of claim 7, wherein the apical dendrite controls whether an event is a burst or a single spike.

9. The method of claim 1, wherein propagating the feedforward signal through the plurality of feedforward connections associated with the first subset of the plurality of artificial neurons comprises:
mapping the feedforward signal to a query matrix (Q) based on a query weight matrix (W_{q});
mapping the feedforward signal to a key matrix (K) based on a key weight matrix (Wₖ);
computing a first nested inner product by pairwise multiplication and summation of elements in the key matrix and the query matrix, wherein the first nested inner product represents a somatic input to a QK neuron of the spiking transformer model for generating a spiking output at the QK neuron represented as a QK event train;
generating an inhibitory neuron output associated with an inhibitory neuron of the spiking transformer model, based on the QK event trains;
mapping the feedforward signal to a value matrix (V) based on a value weight matrix (Wᵥ); and
computing a second nested inner product by pairwise multiplication and summation of elements in the value matrix and the inhibitory neuron output, wherein the second nested inner product represents a somatic input to a V neuron of the spiking transformer model for generating a spiking output at the V neuron represented as a V event train.

10. The method of claim 1, wherein the plurality of artificial neurons represents a plurality of spiking neurons, each comprising a basal dendrite and an apical dendrite, and wherein updating the synaptic weights comprises:
receiving the feedback signal at an apical dendrite of a current artificial neuron of the plurality of artificial neurons;
receiving an eligibility trace associated with a previous artificial neuron of the plurality of artificial neurons; and
updating a synaptic weight matrix of the current artificial neuron when the burst-dependent local learning rule indicates that the feedback signal satisfies a gating condition for plasticity associated with the current artificial neuron, the burst-dependent local learning rule being determined based on the received feedback signal, the eligibility trace and a pre-determined learning rate.

11. The method of claim 1, wherein the spiking transformer model output represents an instantaneous event rate, and the target output represents a target event rate.

12. The method of claim 1, further comprising:
prior to receiving the training set, generating the training set by encoding an input data representing a sequence of tokens into the temporal spike trains using a biologically inspired encoding scheme.

13. The method of claim 1, further comprising:
outputting a trained spiking transformer model configured for deployment on neuromorphic hardware.

14. A neuromorphic computing device comprising:
one or more neuromorphic cores configured to implement a set of artificial neurons;
a memory; and
a processing circuitry to implement the set of artificial neurons to train a spiking transformer model by:
receiving a first training set including multiple spike trains; and
training the spiking transformer model in a first stage using the first training set, wherein training comprises performing a plurality of training iterations for training the spiking transformer model, each training iteration comprising:
propagating a feedforward signal through a plurality of feedforward connections of the spiking transformer model, the feedforward connections associated with either a first subset of the plurality of artificial neurons configured to compute a nested inner product (NIP) or a second subset of the plurality of artificial neurons configured to compute a weighted inner product (WIP), to generate a spiking transformer model output;
determining a loss based on a comparison of the spiking transformer model output to a target output;
encoding the loss in a feedback signal for propagating through a plurality of feedback connections of the spiking transformer model; and
updating synaptic weights of the spiking transformer model based on a simultaneous processing of the feedforward signal and the feedback signal using a burst-dependent local learning rule.

15. The neuromorphic computing device of claim 14, wherein the feedforward signal is encoded with rates of spikes and the feedback signal is encoded with rates of bursts.

16. The neuromorphic computing device of claim 14, wherein the feedforward signal and the feedback signal are encoded with time to first spike (TTFS) encoding.

17. The neuromorphic computing device of claim 14, wherein feedforward connections and feedback connections are communicated via burst multiplexing.

18. The neuromorphic computing device of claim 14, wherein the plurality of artificial neurons represents a plurality of spiking neurons, each comprising a basal dendrite and an apical dendrite, and wherein the apical dendrite controls whether an event is a burst or a single spike.

19. The neuromorphic computing device of claim 14, wherein the processing circuitry implements the set of artificial neurons to propagate the feedforward signal through the plurality of feedforward connections associated with the first subset of the plurality of artificial neurons by:
mapping the feedforward signal to a query matrix (Q) based on a query weight matrix (W_{q});
mapping the feedforward signal to a key matrix (K) based on a key weight matrix (Wₖ);
computing a first nested inner product by pairwise multiplication and summation of elements in the key matrix and the query matrix, wherein the first nested inner product represents a somatic input to a QK neuron of the spiking transformer model for generating a spiking output at the QK neuron represented as a QK event train;
generating an inhibitory neuron output associated with an inhibitory neuron of the spiking transformer model, based on the QK event trains;
mapping the feedforward signal to a value matrix (V) based on a value weight matrix (Wᵥ); and
computing a second nested inner product by pairwise multiplication and summation of elements in the value matrix and the inhibitory neuron output, wherein the second nested inner product represents a somatic input to a V neuron of the spiking transformer model for generating a spiking output at the V neuron represented as a V event train.

20. A non-transitory computer-readable medium having machine-executable instructions stored thereon, the machine-executable instructions, when executed by a processor of a neuromorphic computing device, cause the device to train a spiking transformer model, the spiking transformer model comprising a plurality of artificial neurons and a plurality of artificial synapses, the instructions, when executed by the device, cause the device to perform operations comprising:
receiving a first training set including multiple spike trains; and
training the spiking transformer model in a first stage using the first training set, wherein training comprises performing a plurality of training iterations for training the spiking transformer model, each training iteration comprising:
propagating a feedforward signal through a plurality of feedforward connections of the spiking transformer model, the feedforward connections associated with either a first subset of the plurality of artificial neurons configured to compute a nested inner product (NIP) or a second subset of the plurality of artificial neurons configured to compute a weighted inner product (WIP), to generate a spiking transformer model output;
determining a loss based on a comparison of the spiking transformer model output to a target output;
encoding the loss in a feedback signal for propagating through a plurality of feedback connections of the spiking transformer model; and
updating synaptic weights of the spiking transformer model based on a simultaneous processing of the feedforward signal and the feedback signal using a burst-dependent local learning rule.
